(19) United States
(12) Patent Application Publication
(10) Pub. No.: US 2026/0124937 A1
(43) Pub. Date: May 7, 2026

(54) BATTERY CONTROL SYSTEM AND SERVER

(71) Applicant: AISIN CORPORATION, Kariya, Aichi (JP)

(72) Inventors: Yukio SUGIURA, Kariya-shi (JP); Yasuhiko KOBAYASHI, Kariya-shi (JP); Kohei TSUDA, Kariya-shi (JP)

(73) Assignee: AISIN CORPORATION, Kariya, Aichi (JP)

(21) Appl. No.: 19/119,240

(22) PCT Filed: Nov. 7, 2023
(86) PCT No.: PCT/JP2023/039991

§ 371 Date: Apr. 8, 2025

(30) Foreign Application Priority Data
Nov. 17, 2022 (JP) 2022-183874

(51) Int. Cl. B60L 53/10; B60L 53/62; B60L 53/66; B60L 53/68

(52) U.S. Cl. CPC B60L 53/11; B60L 53/62; B60L 53/66; B60L 53/68

(57) ABSTRACT

A battery control system includes: an acquisition unit configured to acquire either or both of reservation information indicating a reservation time for a charging facility configured to perform charging of a battery mounted on a vehicle and surrounding vehicle information indicating any surrounding vehicle located within a predetermined range including the charging facility; and a determination unit configured to determine, based on either or both of the reservation information and the surrounding vehicle information, whether a conflict of the charging is estimated to occur at the charging facility. The determination unit is configured to temporarily reduce a battery protection function when the conflict of the charging is estimated to occur. The battery protection function is a function to restrain degradation of the battery.

### TECHNICAL FIELD

The present disclosure relates to battery control systems and servers.

### BACKGROUND ART

Patent Document 1 and Patent Document 2 disclose a system for charging a battery mounted on a vehicle. Specifically, Patent Document 1 discloses a system configured to, when a reservation for a second vehicle is made after a first vehicle being charged, change the charge end time of the first vehicle to an earlier time to bring forward the charge start time of the second vehicle. Patent Document 2 discloses a system configured to, when there is any vehicle that has made a charging reservation other than a vehicle being charged, set the charging time of the vehicle being charged in such a manner that the greater the remaining battery capacity of the vehicle being charged, the shorter its charging time is made than the charging time set based on a request from the user of the vehicle being charged.

### RELATED ART DOCUMENTS

### Patent Documents

Patent Document 1: Japanese Unexamined Patent Application Publication No. 2013-85343 (JP 2013-85343 A)

Patent Document 2: Japanese U.S. Pat. No. 6,551,118 (JP 6551118 B)

### SUMMARY OF THE DISCLOSURE

### Problem to Be Solved by the Disclosure

The configuration of Patent Document 1 can reduce the charger wait time of the second vehicle by changing the charge end time of the first vehicle to an earlier time. However, the first vehicle may not be able to be charged in a manner the user desires (i.e., the first vehicle may not have a sufficient amount of charge). The configuration of Patent Document 2 allows a vehicle to have a sufficient amount of charge because the vehicle is charged according to the remaining battery capacity. However, this configuration may increase the charger wait time of any other vehicle that has reserved a charging facility.

The present disclosure was made in view of the above issues, and an object of the present disclosure is to provide a system that increases the possibility of reducing the charger wait time of any other vehicle that has reserved a charging facility while allowing a vehicle being charged to have an amount of charge desired by a user of the vehicle.

### Means for Solving the Problem

In order to achieve the above object, a battery control system of the present disclosure includes: an acquisition unit configured to acquire either or both of reservation information indicating a reservation time for a charging facility configured to perform charging of a battery mounted on a vehicle and surrounding vehicle information indicating any surrounding vehicle located within a predetermined range including the charging facility, and a determination unit configured to determine, based on either or both of the reservation information and the surrounding vehicle information, whether a conflict of the charging is estimated to occur at the charging facility. The determination unit is configured to temporarily reduce a battery protection function when the conflict of the charging is estimated to occur. The battery protection function is a function to restrain degradation of the battery.

That is, in the battery control system, when a charging conflict is estimated to occur such as when there is another vehicle that has reserved the charging facility, the battery protection function, namely the function to restrain degradation of the battery, is temporarily reduced. Temporarily reducing the battery protection function can increase the charging speed of the battery, and as a result, can bring forward the charge end time of the battery of the vehicle being charged while allowing the battery to have a sufficient amount of charge. Since it is possible to bring the charge end time forward, the charger wait time of a vehicle that has a reservation etc. can be reduced.

### BRIEF DESCRIPTION OF THE DRAWINGS

FIG. 1 is a block diagram of a battery control system.

FIG. 2 is a diagram showing an example of reservation information.

FIG. 3 is a diagram showing an example of charging facility information.

FIG. 4 is a flowchart showing an example of a battery control process.

FIG. 5 is an example of a timing chart showing changes in SOC etc. when a battery control process of FIG. 4 is performed.

### MODES FOR CARRYING OUT THE DISCLOSURE

Embodiments of the present disclosure will be described in the following order.
(1) Configuration of Battery Control System:
(2) Battery Control Process:
(3) Other Embodiments:

### (1) Configuration of Battery Control System

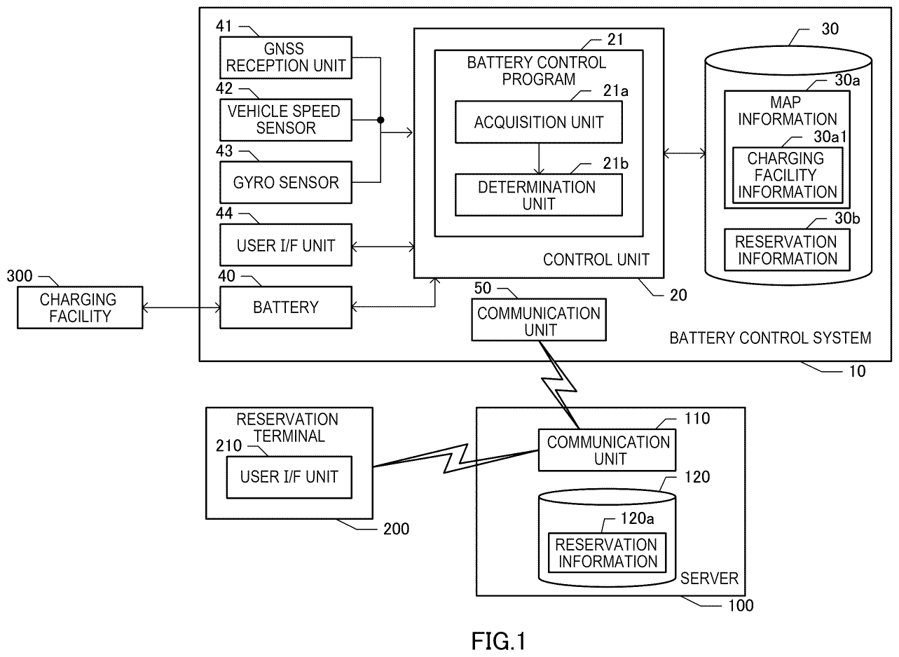

FIG. 1 is a block diagram showing the configuration of a battery control system 10 mounted on a vehicle. In the present embodiment, the battery control system 10 is mounted on a vehicle. The battery control system 10 according to the present embodiment cooperates with a server 100 and a charging facility 300. The vehicle according to the present embodiment is a battery electric vehicle (BEV: Battery Electric Vehicle) that is equipped with a battery 40, namely a rechargeable storage battery, and that is driven with power stored in the battery 40. When the battery 40 of the vehicle has a low SOC (State Of Charge), the battery 40 is charged at the charging facility 300 provided in, for example, a rest facility (e.g., a rest area) on a highway, a commercial facility, a filling station, or a charging station.

The server 100 manages reservation information for the charging facility 300 and information indicating that the charging facility 300 is in use. The server 100 is, for example, a stationary general-purpose computer or a cloud server. The server 100 communicates with vehicles via a communication unit 110, and can also communicate with a reservation terminal 200 that allows to make reservations for charging facilities. The reservation terminal 200 is, for example, a terminal that is used by a user who uses the battery charging facility 300. The reservation terminal 200 is, for example, a PC, a tablet, or a smartphone. The reservation terminal 200 includes a user I/F unit 210. The user I/F unit 210 is an interface unit for receiving instructions from the user and providing various types of information to the user. The user operates the user I/F unit 210 to reserve the charging facility 300. When a reservation for the charging facility 300 is made by the user, information on the reservation (reservation information) is sent to the server 100. The server 100 receives the information via the communication unit 110 and records it on a recording medium 120 as reservation information 120a.

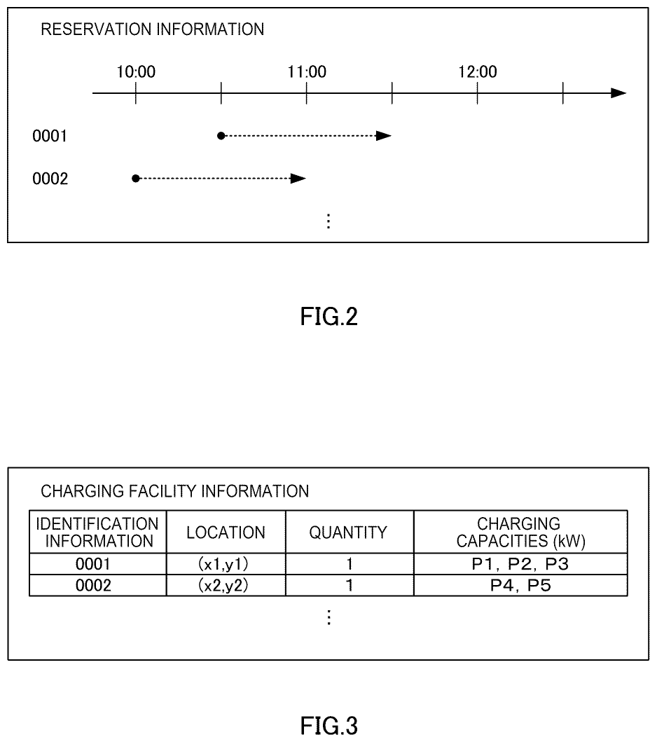

FIG. 2 is a diagram showing an example of the reservation information 120a. The reservation information 120a is information indicating the reservation time for (i.e., scheduled use of) the charging facility 300. In the reservation information 120a, information indicating the reservation time for each charging facility is associated with identification information identifying the charging facilities. In the present embodiment, the reservation time is defined by defining the charge start time and charge end time for each charging facility. For example, in the example shown in FIG. 2, a charging facility identified by identification information “0001” is reserved from 10:30 to 11:30. A charging facility identified by identification information “0002” is reserved from 10:00 to 11:00. During these periods, users other than those who have the reservations cannot use the charging facilities. During periods with no reservations, any user can use available charging facilities, if any.

When the server 100 receives, from the battery control system 10, a request to send reservation information corresponding to the charging facility 300 to be used by the vehicle equipped with the battery control system 10, the server 100 sends the reservation information to the battery control system 10 via the communication unit 110 by the function of a control unit, not shown.

The battery control system 10 includes a control unit 20 including a CPU, a RAM, a ROM, etc., a recording medium 30, the battery 40, a GNSS reception unit 41, a vehicle speed sensor 42, a gyro sensor 43, a user I/F unit 44, and a communication unit 50. The control unit 20 can execute a battery control program 21 stored in the ROM etc.

The recording medium 30 records map information 30a and reservation information 30b. The map information 30a indicates, for example, information on roads etc. that is referred to provide guidance on the route to the charging facility 300. In the present embodiment, the map information 30a includes node data, link data, shape interpolation point data, and facility data. The node data is data indicating the locations of intersections. The link data indicates road sections, and is associated with nodes corresponding to end points of each road section. That is, the link data indicates links connecting the nodes. In the present embodiment, the link data includes information indicating road attributes of each road section indicated by the link data. The road attributes include information indicating the road types such as highway, local road, and narrow street. The shape interpolation point data indicating the locations of shape interpolation points for identifying the shapes of the roads between the nodes is associated with the link data.

The facility data indicates the names, locations, and attributes of facilities located around the roads etc. The facilities in the present embodiment include various types of facilities. For example, the names, locations, attributes, etc. of resting areas such as rest areas, stores, trademark facilities, public facilities, etc. are defined as the facility data. The facility data in the present embodiment further includes information on charging facilities. The charging facilities are facilities for charging the battery 40 of the vehicle. The facility data includes charging facility information 30a1 on the charging facilities.

FIG. 3 shows an example of the charging facility information 30a1. The charging facility information 30a1 includes identification information, locations, quantity, and charging capacities (kW) of the charging facilities. The identification information is information for identifying the charging facilities, and the location, quantity, and charging capacity are defined for each piece of identification information. The location is the coordinates of a charging facility, and is defined using a coordinate system for specifying the locations of facilities in the map information 30a (e.g., a latitude and longitude coordinate system). The quantity indicates the number of chargers installed in the same charging facility. In the example shown in FIG. 3, the quantity is “1” for each charging facility.

The charging capacity indicates the power that can be output at a charging facility. In the example shown in FIG. 3, each charging facility can output power in a plurality of patterns with different power values. The charging capacities of the charging facility corresponding to the identification information “0001” are indicated by “P1, P2,P3.” Power is the product of a current and a voltage. If the value of the current or voltage can be controlled, the charging capacity (i.e., power) can be controlled. In the present embodiment, the value of the power is controlled by controlling the value of the voltage. In the example shown in FIG. 3, the charging capacities are indicated by signs such as P1, P 2, . . . , but the actual values indicated by the signs are, for example, values such as 150 KW and 80 kW. The charging capacity is selected from among P1, P2, P3, etc. by the user according to, for example, the state of the vehicle (battery temperature, battery SOC), or may be selected by the control unit 20 of the vehicle. The charging capacity need only indicate the amount of energy that can be output for charging at a charging facility, and may be defined in various other ways such as by the magnitude of current or voltage that can be output for charging.

The reservation information 30b is information indicating the reservation time for (i.e., scheduled use of) a charging facility to be used by the vehicle. By the function of an acquisition unit 21a that will be described later, the control unit 20 acquires reservation information corresponding to the identification information of the charging facility 300 to be used by the vehicle out of the reservation information 120a recorded on the recording medium 120 of the server 100. The acquired reservation information is recorded on the recording medium 30 as the reservation information 30b.

The battery 40 is, for example, a secondary battery such as a lithium-ion battery or a nickel metal hydride battery, or a high-voltage energy storage device including a capacitor etc. The battery 40 is electrically connected to a motor (not shown) serving as a driving power source, and the vehicle is driven with power supplied from the battery 40 to the motor. When the battery 40 has a low SOC, the user charges the battery 40 at the charging facility described above. The battery 40 is equipped with sensors, not shown. The sensors output information indicating the temperature and SOC of the battery. Based on the outputs of the sensors, the control unit 20 periodically acquires the temperature and SOC of the battery 40 and records the acquired information on the recording medium 30.

The GNSS reception unit 41 is a device that receives signals from a Global Navigation Satellite System. The GNSS reception unit 41 receives radio waves from navigation satellites and outputs, via an interface, not shown, a signal for calculating the location of the vehicle. The control unit 20 acquires this signal to acquire the location of the vehicle. The vehicle speed sensor 42 outputs a signal corresponding to the rotational speed of wheels of the vehicle. The control unit 20 receives this signal via an interface, not shown, to acquire the vehicle speed.

The gyro sensor 43 detects angular acceleration of the vehicle when the vehicle turns in a horizontal plane, and outputs a signal corresponding to the direction of the vehicle, The control unit 20 acquires this signal to acquire the direction of travel of the vehicle. The vehicle speed sensor 42, the gyro sensor 43, etc. are used to identify the traveling trajectory of the vehicle. In the present embodiment, the control unit 20 identifies the location of the vehicle based on the point of departure and traveling trajectory of the vehicle, and corrects, according to the output signal from the GNSS reception unit 41, the current location of the vehicle identified based on the point of departure and the traveling trajectory. The control unit 20 also performs a map matching process based on the trajectory of the location of the vehicle and the map information 30a to identify the location of the vehicle on the road.

The user I/F unit 44 is an interface unit for receiving instructions from the user and providing various types of information to the user, and includes a display unit that is a touch panel display, not shown, an input unit such as a switch, and an output unit such as a speaker. The user I/F unit 210 in the reservation terminal 200 has the same configuration as this user I/F unit. The communication unit 50 includes a circuit for wirelessly communicating with other devices. In the present embodiment, the control unit 20 can send and receive information to and from the server 100 by wireless communication via the communication unit 50.

The control unit 20 can execute a program stored in the recording medium 30 or the ROM. In the present embodiment, the battery control program 21 can be executed as this program. When the battery 40 is to be charged at the charging facility 300, the battery 40 may not be able to be sufficiently charged depending on the reservation status of the charging facility 300, because the reservation time for another vehicle may come before the amount of charge of the battery 40 reaches a target value. In such a case, the battery 40 may be charged until its amount of charge reaches the target value. However, this increases the wait time of another vehicle that has reserved the charging facility 300. Therefore, in the present embodiment, the control unit 20 controls the battery 40 so as to increase the possibility of reducing the charger wait time of another vehicle that has reserved the charging facility 300 while allowing the amount of charge of the battery 40 to reach the target value. The battery control program 21 is a program for performing this battery control. When the battery control program 21 is executed, the control unit 20 functions as the acquisition unit 21a and a determination unit 21b. In the following description, the processes that are described to be performed by the acquisition unit 21a and the determination unit 21b are processes implemented by the control unit 20.

The acquisition unit 21a has a function to acquire reservation information for the charging facility 300 to be used by the vehicle. That is, the control unit 20 acquires reservation information corresponding to the charging facility 300 from the server 100 via the communication unit 50 by the function of the acquisition unit 21a. The reservation information includes a reservation time defining the charge start time and charge end time at the charging facility 300, and serves as a parameter for determining whether the time when charging of the vehicle will be completed does not fall in the reservation time for another vehicle at the charging facility 300 (estimates whether a conflict does not occur). The reservation information acquired by the function of the acquisition unit 21a is recorded on the recording medium 30 as the reservation information 30b.

The determination unit 21b has a function to determine, based on the reservation information, whether a charging conflict is estimated to occur at the charging facility 300. Specifically, the control unit 20 estimates that a charging conflict occurs when it is determined, based on the reservation information acquired by the function of the acquisition unit 21a, that the time when charging is estimated to be completed in the case where the battery 40 is charged using a battery protection function, namely a function to restrain degradation of the battery 40, falls in the reservation time for the battery of another vehicle. When it is estimated by the function of the determination unit 21b that a charging conflict occurs at the charging facility 300, the control unit 20 temporarily reduces the battery protection function, namely the function to restrain degradation of the battery 40.

The battery protection function herein refers to a function to restrain degradation of the battery by setting a limit value (upper limit value) of the temperature of the battery 40. When the battery 40 is charged or discharged, the battery 40 generates heat and the temperature of the battery rises. If the temperature of the battery 40 rises and goes out of a predetermined temperature range, the output of the battery 40 will decrease and the service life of the battery 40 will become shorter. Therefore, when there is no charging conflict with any other vehicle (that is, when in a normal condition), the control unit 20 sets the upper limit of the battery temperature to a default temperature (e.g., 40° C.) as a temperature limit of the battery 40. The control unit 20 also limits the voltage value for charging to a default value such that the temperature of the battery 40 does not become higher than the default temperature. The control unit 20 thus controls charging or discharging of the battery 40 when there is no charging conflict with any other vehicle. The output and service life of the battery 40 are affected not only by the temperature of the battery 40 becoming high, but also by the temperature of the battery 40 becoming low. Therefore, in consideration of the output and the service life, it is preferable to control the temperature within a predetermined range (e.g., 20° C. to 30° C.).

On the other hand, as described above, when it is determined by the function of the determination unit 21b that a charging conflict is estimated to occur, the control unit 20 temporarily reduces the battery protection function. Temporarily reducing the battery protection function is either or both of the following controls: a control of increasing the temperature limit of the battery 40 by a predetermined temperature from the default temperature; and a control of cooling the battery 40. Specifically, when the control unit 20 estimates by the function of the determination unit 21b that a charging conflict occurs, the control unit 20 increases the temperature limit of the battery 40 to, for example, 50° C. by increasing the temperature limit by the predetermined temperature (e.g., 10° C.) from the default temperature (e.g., 40° C.). The charging speed of the battery 40 is thus increased by, for example, increasing the output voltage from the charging facility 300 from the default value. Increasing the charging speed can increase the possibility of avoiding the charge end time falling in the reservation time for another vehicle while allowing the amount of charge to reach the target value set by the user.

The control unit 20 may cool the battery 40 when it is estimated by the function of the determination unit 21b that a charging conflict occurs. When no charging conflict occurs, the temperature of the battery 40 is limited to the default temperature, and therefore, there is no need to cool battery 40. However, when a charging conflict is estimated to occur, the charging speed is increased by increasing the voltage etc. as described above. Therefore, the battery 40 generates more heat, and the temperature of the battery 40 rises. Accordingly, the control unit 20 cools the battery 40 when a charging conflict is estimated to occur. For example, the battery 40 is cooled by supplying a cooling medium to the battery 40 by driving an electric oil pump (not shown). Cooling the battery 40 consumes power. Therefore, the control unit 20 controls power consumption needed for the cooling to less than at least the amount of charge of the battery 40. More specific forms of the control unit 20 will be described later with reference to a flowchart.

This configuration can increase the possibility of reducing the charger wait time of another vehicle that has reserved the charging facility while allowing the vehicle being charged to have the amount of charge desired by the user (allowing the amount of charge to reach the target value).

### (2) Battery Control Process

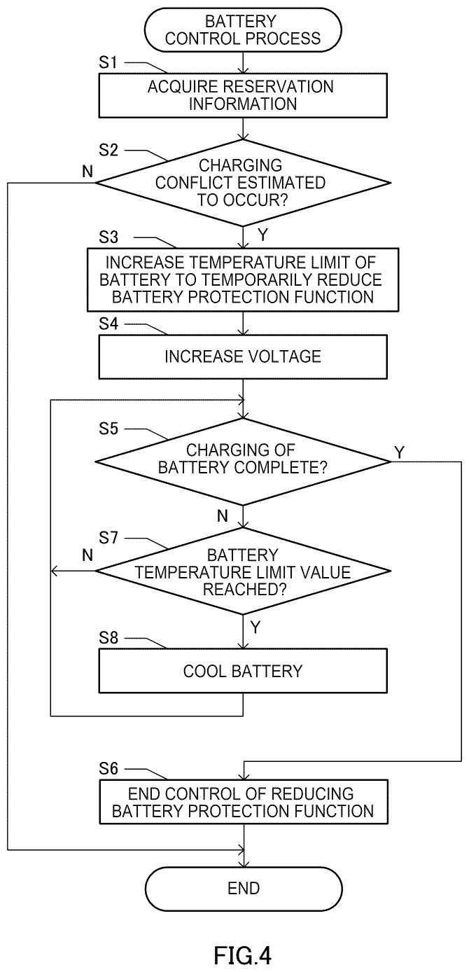

Next, a battery control process that is performed by the control unit 20 will be described. FIG. 4 is a flowchart showing an example of the battery control process. The control unit 20 performs the battery control process when, for example, a charging cable is connected to the vehicle at the charging facility 300 and charging of the battery 40 is started. The flowchart chart shown in FIG. 4 is repeatedly performed at predetermined short intervals.

When the battery control process is started, the control unit 20 first acquires reservation information by the function of the acquisition unit 21a (step S1). Specifically, the control unit 20 acquires, by the function of the acquisition unit 21a, identification information of the charging facility 300 connected to the vehicle. The control unit 20 acquires, by the function of the acquisition unit 21a, reservation information corresponding to the identification information of the charging facility 300 to be used by the vehicle from the server 100. The reservation information is assumed to have been input from the reservation terminal 200 described above and recorded on the recording medium 120 of the server 100. The reservation information may include a charging reservation that has already been made for another vehicle, and may include a reservation that is made during charging of the vehicle. When the control unit 20 acquires the reservation information from the server 100, the control unit 20 records it on the recording medium 30 as the reservation information 30b. After the control unit 20 acquires the reservation information, the process proceeds to step S2.

In step S2, the control unit 20 determines by the function of the determination unit 21b whether a charging conflict is estimated to occur at the charging facility 300. Specifically, the control unit 20 refers to the reservation information 30b to identify the reservation time for another vehicle at the same charging facility as the charging facility 300 used by the vehicle. The control unit 20 then determines whether the time when charging is estimated to be completed in the case where the vehicle is charged using the battery protection function falls in the identified reservation time for another vehicle. That is, the control unit 20 determines whether charging of another vehicle conflicts with (overlaps) charging of the vehicle.

The time when charging of the vehicle is estimated to be completed in the case where the vehicle is charged using the battery protection function may be calculated by various methods. For example, the control unit 20 can calculate the time when charging is estimated to be completed from the battery capacity (e.g., 30 kWh), the charging speed (e.g., 50% /h), the current SOC of the battery 40 (e.g., 30%), and the SOC at which charging is to be completed (target value: e.g., 80%). The charging speed means the amount of SOC that can be increased per unit time. The charging speed is defined in advance for each charging capacity, and is defined based on, for example, the amount of change in SOC due to charging and the time needed for charging. When no charging conflict occurs, the control unit 20 charges the battery 40 using the protection function for the battery 40. The time needed for charging in the case where the battery protection function is used can be calculated by dividing the amount of change in SOC due to charging by the charging speed. For example, in order to restore the current SOC (30%) of the battery 40 to the target SOC (80%), the SOC of the battery 40 needs to be increased by 50%. In this case, the control unit 20 divides the amount of change, namely 50%, by the speed (50% /h). The control unit 20 thus estimates that charging will be completed one hour after the charge start time (or the current time). The control unit 20 then determines whether the time when charging is estimated to be completed conflicts with the reservation time for another vehicle. As described above, the control unit 20 obtains the time when charging is estimated to be completed, and determines whether the time when charging is estimated to be completed in the case where the charging is performed using the battery protection function falls in the reservation time for another vehicle.

When No in step S2, that is, when the time when charging is estimated to be completed in the case where the charging is performed using the battery protection function does not fall in the reservation time for another vehicle, the control unit 20 ends the process shown in FIG. 4. On the other hand, when Yes in step S2, that is, when the time when charging is estimated to be completed in the case where the charging is performed using the battery protection function falls in the reservation time for another vehicle, and therefore, the control unit 20 estimates that a charging conflict occurs, the process proceeds to step S3.

In step S3, the control unit 20 increases the temperature limit of the battery 40 by the function of the determination unit 21b to temporarily reduce the battery protection function. Based on the determination in step S2, there is a possibility of a charging conflict with another vehicle if the charging is performed using the battery protection function. Therefore, the control unit 20 temporarily reduces the battery protection function by increasing the temperature limit of the battery 40 by the predetermined temperature (e.g., 10° C.) from the default temperature (e.g., 40° C.). That is, in the present embodiment, the control unit 20 increases the temperature limit of the battery from 40° C. to 50° C.

The control unit 20 then increases the voltage for charging the battery 40 by the function of the determination unit 21b (step S4). That is, since a charging conflict is estimated to occur, the SOC of the battery 40 may not reach the target value if the charging is performed using the battery protection function. Accordingly, in step S4, the control unit 20 increases the output voltage from the charging facility 300 to increase the power supplied to the battery 40. The control unit 20 thus increases the charging speed. This is because increasing the charging speed can increase the possibility of avoiding the charge end time falling in the reservation time for another vehicle while allowing the amount of charge to reach the target value set by the user.

Increasing the voltage will be specifically described. As described above in connection with the charging facility information 30a1, each charging facility can output power in a plurality of patterns with different charging capacities, and therefore, each pattern has a different voltage value. Although the current value may also be different for each pattern, it is assumed in the present embodiment that the voltage value is different for each pattern. In step S4, the control unit 20 selects which charging capacity to use to charge the battery 40 from among the plurality of charging capacities, and causes the charging facility 300 to control the voltage to the voltage corresponding to the selected charging capacity.

The determination as to which charging capacity to select can be made based on the sums of the amount by which the temperature of the battery 40 increases during charging with each charging capacity and the current temperature of the battery 40. In consideration of protecting the battery 40, it is preferable to select such a charging capacity that the sum is equal to or less than the increased temperature limit. Specifically, the control unit 20 identifies the amount of heat generated by the battery 40 per unit time. The amount of heat generated per unit time can be identified for each charging capacity by using, for example, the internal resistance, the number of cells, and the number of parallel connections of the battery 40. The amount of increase in temperature per unit time can be identified for each charging capacity from the amount of heat generated per unit time and the specific heat and mass of the battery 40. When the amount of increase in temperature per unit time is identified for each charging capacity, the control unit 20 calculates, for each charging capacity, the amount by which the temperature of the battery 40 increases by the time the charging is completed, based on the product of the amount of increase in temperature per unit time and the time it takes to complete charging of the battery 40 (i.e., charging to the target value). The time it takes to complete charging of the battery 40 is calculated by dividing the amount of charge needed to restore the SOC of the battery 40 to the target value (target SOC value-current SOC) by the charging speed. The time it takes to complete charging of the battery 40 is supposed to be equal to or less than the time from the current time to the reservation time for charging of another vehicle in order to avoid overlap with the reservation time for another vehicle. Therefore, the control unit 20 selects, from among the charging capacities, such a charging capacity that the sum of the current time and the time it takes to complete charging is not later than the reservation time.

After the control unit 20 calculates the amount by which the temperature increases by the time the charging is completed, the control unit 20 adds this amount to the current temperature of the battery 40 to obtain, for each charging capacity, the maximum temperature of the battery 40 during charging. The control unit 20 then selects, from among the charging capacities, such a charging capacity that the maximum temperature is equal to or less than the temporarily increased temperature limit (e.g., 50° C.). In other words, if the control unit 20 charges the battery 40 with such a charging capacity that the maximum temperature is higher than the increased temperature limit, the temperature of the battery 40 will increase excessively, which will accelerate degradation of the battery 40. Therefore, the control unit 20 will not select such a charging capacity.

When there is a plurality of charging capacities corresponding to the maximum temperature equal to or less than the increased temperature limit, the control unit 20 selects the lowest charging capacity (i.e., the lowest voltage, in other words, the smallest amount of increase in temperature per unit time and the smallest amount of heat generated per unit time) from among the plurality of charging capacities. When there is no such charging capacity that the time it takes to complete charging of the battery 40 is equal to or less than the time from the current time to the reservation time, and it is not possible to select such a charging capacity that the sum of the current time and the time it takes to complete charging is not later than the reservation time, the battery 40 is charged while being cooled in step S8 described later.

As described above, the control unit 20 selects which charging capacity to use to charge the battery 40 based on the amount by which the temperature of the battery 40 increases by the reservation time for another vehicle with which a conflict is estimated to occur. After the control unit 20 determines which charging capacity to select, the control unit 20 increases the voltage to a voltage value corresponding to the selected charging capacity in order to perform charging with this charging capacity. That is, the control unit 20 instructs the charging facility 300 to increase the voltage.

The control unit 20 then determines, by the function of the determination unit 21b, whether charging of the battery 40 is complete (step S5). That is, it is determined whether the SOC of the battery 40 has reached the target value (e.g., 80%). Specifically, by the function of the determination unit 21b, the control unit 20 acquires the current SOC of the battery 40 from the sensor that outputs information on the SOC, and determines whether the acquired SOC value has reached the target value. Whether the SOC of the battery 40 has reached the target value can also be determined from the value of the voltage increased in step S4. In other words, when the charging capacity selected in step S4 is a charging capacity with which the charge end time does not fall in the reservation time for another vehicle, it is possible to perform the charging to the target SOC. Therefore, in this case, it can be determined that the SOC has reached the target value when the current time reaches the reservation time for another vehicle. When the control unit 20 determines in step S5 that charging of the battery 40 is complete, the process proceeds to step S6.

In step S6, the control unit 20 ends the control of increasing the temperature limit of the battery 40 by the function of the determination unit 21b. That is, when charging of the battery 40 is completed, the control unit 20 ends the control of increasing the battery temperature limit, namely the control performed in step S3, to end the control of temporarily reducing the battery protection function. In step S6, the control unit 20 reduces the voltage increased in step S4.

On the other hand, when the determination result in step S5 described above is No because charging of the battery 40 is not completed, the control unit 20 determines, by the function of the determination unit 21b, whether the temperature of the battery 40 has reached the limit value (step S7). That is, the control unit 20 determines whether the temperature of the battery 40 has reached the temperature limit increased in step S3. For example, the determination result in step S5 is negative when it is determined that the SOC of the battery 40 acquired from the sensor described above has not reached the target value. Another possible case for the negative determination result is when the charging cannot be completed by the reservation time for charging another vehicle in the case where the charging is performed with the charging capacity selected when increasing the voltage in step S4.

As described above, the battery 40 is equipped with the sensors, not shown. Therefore, in step S7, the control unit 20 acquires the temperature of the battery 40 from the sensor by the function of the determination unit 21b. When the control unit 20 determines, by the function of the determination unit 21b, that the acquired temperature of the battery 40 has not reached the limit value, the process returns to step S5.

On the other hand, when the control unit 20 determines, by the function of the determination unit 21b, that the acquired temperature of the battery 40 has reached the limit value, the process proceeds to step S8. In step S8, the control unit 20 cools the battery 40 by the function of the determination unit 21b. That is, since it is determined that the temperature of the battery 40 has reached the limit value, the control unit 20 cools the battery 40 in order to reduce the temperature of the battery 40. The battery 40 can be cooled by various methods as long as the temperature of the battery 40 can be controlled to at least the limit value or less. For example, the cooling can be performed by supplying a cooling medium to the battery 40 by driving the electric oil pump (not shown). The cooling medium may be shared with other cooling systems. For example, the cooling medium may be shared with part of a cooling system for air conditioning, part of a cooling system for a motor for driving a vehicle, etc. The control unit 20 consumes power when cooling the battery 40. Therefore, the control unit 20 controls the amount of power needed for the cooling to less than at least the amount of charge of the battery 40. For example, it is possible to make a correction such as subtracting the cooling rate due to the cooling from the temperature increase rate due to the charging of the battery 40. After the control unit 20 performs the cooling process, the process returns to step S5.

When the temperature of the battery 40 has not reached the limit value in step S7 described above, and after the control unit 20 cools the battery 40 in step S8, the process returns to step S5, and the control unit 20 continues to charge the battery 40. This process ends when the charging of the battery 40 is complete (Y in step S5). This process otherwise ends a predetermined time before the reservation time for another vehicle (e.g., a few minutes before the reservation time).

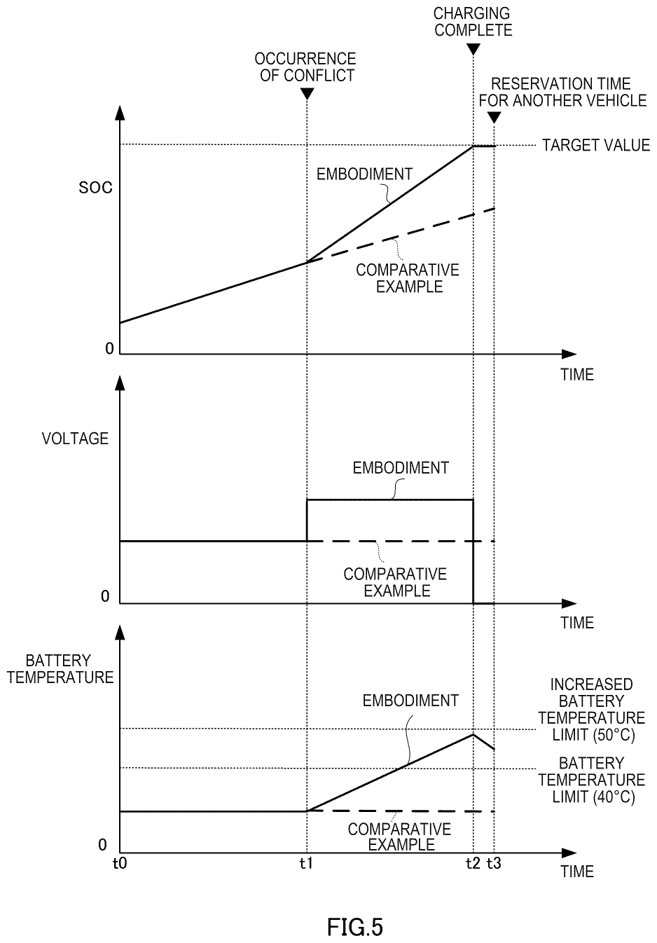

Next, a timing chart showing changes in SOC etc. of the battery 40 when the battery control process of FIG. 4 is performed will be described. FIG. 5 shows the timing chart, and shows changes in SOC, voltage, and battery temperature. In FIG. 5, the abscissa represents time, and the ordinate represents SOC, voltage, and battery temperature. The timing chart shown in FIG. 5 illustrates an example in which a charging conflict occurs because a reservation for charging another vehicle is made for the same charging facility 300 while the vehicle is being charged at the charging facility 300 without a reservation. This timing chart particularly shows an example in which charging to the target value is completed before the reservation time for another vehicle and the temperature of the battery 40 does not become higher than the increased temperature limit. In the example of FIG. 5, continuous lines show changes in SOC etc. in the present embodiment, and dashed lines show changes in SOC etc. in a comparative example that is an example in which the charging is performed using the battery protection function without increasing the temperature limit of the battery.

Specifically, first, charging of the battery 40 is started at time t0. At time t0, a charging conflict is not yet estimated to occur at the charging facility 300, and the battery 40 is charged using the battery protection function. After the charging is started, the SOC of the battery 40 starts to increase. At time t0, the battery 40 is charged using the battery protection function as described above. Therefore, the voltage is set to the default value, and the voltage remains constant until time t1 at which a conflict is estimated to occur at the charging facility 300. Regarding the temperature of the battery 40, since the voltage is set to the default value, the amount of heat generated by the battery 40 is reduced. Therefore, the temperature of the battery 40 is lower than the battery temperature limit (40° C.) from time t0 to time t1. The changes in parameters such as SOC from time t0 to time t1 are the same in both the present embodiment and the comparative example.

At time t1, a charging conflict is estimated to occur at the charging facility 300 where the battery 40 of the vehicle is being charged. In the present embodiment, as described above with reference to the flowchart of FIG. 4, the control unit 20 can estimate occurrence of a charging conflict by acquiring the reservation information corresponding to the charging facility 300 where charging is being performed. At time t1, the control unit 20 estimates that the charging conflicts with the reservation time for another vehicle at the charging facility 300, and therefore, estimates that a charging conflict occurs at the charging facility 300. Therefore, the control unit 20 increases the temperature limit of the battery 40. For example, the control unit 20 increases the temperature limit from 40° C. to 50° C.. In other words, the battery protection function is reduced. Then, the control unit 20 increases the voltage for supplying power to the battery 40. Increasing the voltage increases the charging speed of the battery 40. Therefore, in FIG. 5, the rate of change in SOC becomes higher than the rate of change from time t0 to time t1 (i.e., the rate of change during the period in which the charging is performed using the battery protection function). Increasing the voltage also increases the amount of heat generated by the battery 40. Therefore, the temperature of the battery 40 kept constant until time t1 starts to increase, and becomes higher than the original battery temperature limit (40° C.) during the period from time t1 to time t2.

The SOC of the battery 40 then reaches the target value at time t2. That is, the charging of the battery 40 is complete. Therefore, the control unit 20 ends the control of reducing the battery protection function. Since the control unit 20 ends the control of reducing the battery protection function, the control unit 20 reduces the increased voltage at the charging facility 300 to the default value. Since the voltage is reduced, the temperature of the battery 40 starts to decrease, and eventually decreases to the battery temperature limit or less at or after time t3, not shown. At time t3, the reservation time for charging another vehicle comes, and charging of this vehicle is started. As described above, in the present embodiment, the battery 40 can be charged to the target value before the reservation time for charging another vehicle.

On the other hand, in the comparative example, charging is continued using the battery protection function. Therefore, even at and after time t1, the voltage remains constant and the rate of change in SOC also remains constant. Accordingly, the SOC has not reached the target value at time t3 that is the reservation time for another vehicle. When the battery is going to be charged to the target value, the charge start time of another vehicle will be delayed, and this vehicle that has reserved the charging facility will have to wait until the charging is completed.

As described above, in the present embodiment, when it is estimated based on the reservation information that a charging conflict occurs at the charging facility, the temperature limit of the battery 40 is increased, and the voltage for charging the battery 40 is increased. This can increase the charging speed of the battery 40, and as a result, can bring forward the charge end time of the battery 40 of the vehicle being charged while allowing the battery 40 to have a sufficient amount of charge. In particular, in the above embodiment, the time it takes to reach the target value by charging of the battery 40 is calculated, and the battery 40 is charged at such a charging speed that does not cause a conflict with the reservation time for another vehicle. Increasing the charging speed (in other words, increasing the voltage) increases the temperature of the battery 40. In the present embodiment, however, the temperature of the battery is controlled to the increased temperature limit or less. Therefore, in the present embodiment, it is possible to complete charging of the battery 40 by the reservation time for another vehicle at the charging facility while allowing the amount of charge to reach the target value, and it is also possible to reduce the charger wait time of another vehicle.

### (3) Other Embodiments

The above embodiment is an example for carrying out the present disclosure, and various other embodiments can be adopted. In the above embodiment, the control unit 20 estimates occurrence of a conflict at the charging facility 300 based on the reservation information. However, the parameter for estimating occurrence of a conflict is not limited to the reservation information. For example, the control unit 20 may estimate occurrence of a conflict at the charging facility 300 based on surrounding vehicle information indicating surrounding vehicles located within a predetermined range including the charging facility 300 (hereinafter simply referred to as surrounding vehicles).

Specifically, the surrounding vehicle information is acquired by a probe vehicle, not shown. The surrounding vehicle information includes at least location information of the surrounding vehicles located within the predetermined range including the charging facility 300 and information on the current SOCs of the surrounding vehicles. The surrounding vehicle information is sent to, for example, the server 100 and recorded on the recording medium 120. The control unit 20 acquires the surrounding vehicle information from the server 100 by the function of the acquisition unit 21a, and identifies, by the function of the determination unit 21b, the surrounding vehicles currently located within a predetermined distance from the charging facility 300 used by the vehicle. The control unit 20 also identifies, by the function of the determination unit 21b, any surrounding vehicles with an SOC equal to or less than a reference value (e.g., equal to or less than 40%) from among the identified surrounding vehicles. This is because it is highly unlikely that a surrounding vehicle with an SOC higher than the reference value will immediately use the charging facility 300. When the number of identified surrounding vehicles per unit area is equal to or larger than a threshold, the control unit 20 estimates, by the function of the determination unit 21b, that a conflict will occur at the charging facility 300 used by the vehicle. This is because when the number of identified surrounding vehicles per unit area is less than the threshold, the possibility of immediate occurrence of a conflict is low. When the control unit 20 determines, based on the surrounding vehicle information acquired by the function of the acquisition unit 21a, that there is any surrounding vehicle located at the charging facility 300 used by the vehicle, it can be estimated that there is already a surrounding vehicle waiting for a charger. Therefore, the control unit 20 may estimate that a conflict occurs. When occurrence of a conflict is estimated using the surrounding vehicle information, estimation of occurrence of a conflict using the reservation information may or may not be performed.

As described above, by estimating occurrence of a conflict at the charging facility based on the surrounding vehicle information, the control unit 20 can determine not only a conflict with another vehicle that has reserved the charging facility but also the possibility of a conflict with a surrounding vehicle. When a conflict is estimated to occur, the control unit 20 temporarily reduces the battery protection function to increase the voltage for charging. As a result, it is possible to increase the possibility of reducing the charging time of the battery of another vehicle at the charging facility while allowing the amount of charge of the battery 40 to reach the target value.

In the above embodiment, as shown in the reservation information 30b, there is one reservation for the same charging facility 300. However, there may be a plurality of reservations for the same charging facility 300. When the control unit 20 refers to the reservation information 30b and determines that there is a plurality of reservations by the function of the determination unit 21b, the control unit 20 may estimate that a charging conflict will occur. In other words, when there is a plurality of reservations, a conflict is more likely to occur than when there is only one reservation. Therefore, in this case, the control unit 20 performs charging by temporarily reducing the battery protection function, regardless of whether there is a reservation that starts before the time when charging is estimated to be completed in the case where the charging is performed using the battery protection function. That is, when there is a plurality of reservations, the control unit 20 assumes that a conflict will occur at the charging facility 300. As described above, when there is a plurality of reservations for the same charging facility, a conflict is more likely to occur at the same charging facility. However, reducing the battery protection function can reduce the possibility that the target amount of charge set by the user may not be achieved and the possibility that another vehicle may have to wait a long time for a charger.

In the above embodiment, when a conflict is estimated to occur at the charging facility 300, the temperature limit of the battery 40 is increased to reduce the battery protection function, and when the temperature of the battery reaches the increased limit value, the battery 40 is cooled. Either or both of the control of increasing the temperature limit of the battery 40 and the control of cooling the battery 40 need only be performed. In other words, increasing the temperature limit of the battery 40 can increase the voltage and therefore increase the charging speed. This allows the amount of charge to more quickly reach the target value and reduces occurrence of a conflict, compared to the case where the charging is continued using the battery protection function. On the other hand, cooling the battery 40 reduces the temperature of the battery 40. Therefore, the voltage can be increased to increase the charging speed. This also allows the amount of charge to more quickly reach the target value and reduces occurrence of a conflict, compared to the case where the charging is continued using the battery protection function.

In the above embodiment, the vehicle to be charged may be any vehicle that is equipped with a battery and that can charge the battery at a charging facility. Therefore, the vehicle is not limited to a battery electric vehicle (BEV) mentioned above, and may be a plug-in hybrid vehicle, a so-called range extender EV equipped with an engine dedicated to generate electric power, etc.

The charging facility may be any charging facility as long as batteries can be charged at the charging facility. Therefore, the charging facility may be an external facility such as a rest facility on a highway mentioned above, or may be a charging facility installed at home. The charging facility may be a charging facility installed at a workplace, a friend's house, an accommodation facility, etc. There may be a plurality of charging facilities within the same premises.

In the above embodiment, the voltage for charging is increased in order to increase the charging speed of the battery 40. However, the current may be increased instead of the voltage. Alternatively, the voltage value and the current value may be controlled in a coordinated manner.

Each system and device constituting the above embodiment may be configured with fewer devices that share functions. An example of this is a case where at least one system shown in FIG. 1 is configured with the same device as that of one or more other systems. For example, the battery control system 10 and the server 100 may be configured as an integrated device, the server 100 and the reservation terminal 200 may be configured as an integrated device, or the battery control system 10 and the reservation terminal 200 may be configured as an integrated device. Part of the functions of the battery control system 10 (at least part of the acquisition unit 21a and determination unit 21b) may be implemented by the battery control system 10. The system shown in FIG. 1 may be configured with a larger number of systems. For example, at least part of the battery control system 10, server 100, and reservation terminal 200 may be configured as a cloud server.

At least part of the components of the battery control system 10 (acquisition unit 21a, determination unit 21b) or the components of the server 100 may be separately located in a plurality of devices. For example, the server 100 may include the acquisition unit 21a and the determination unit 21b. In this case, the server 100 acquires either or both of the reservation information and the surrounding vehicle information, and determines, based on the acquired information, whether a conflict is estimated to occur at the charging facility. When a conflict is estimated to occur, the server 100 instructs an external device located outside the vehicle or the charging facility to temporarily reduce the battery protection function. Other possible configurations include a configuration in which part of the components of the above embodiment is omitted and a configuration in which the process is changed or omitted.

The technique of the present disclosure is also applicable as a program or a method. The system, program, and method described above may be implemented as an independent device or may be implemented using components shared with various parts provided in the vehicle, and include various forms. Modifications can be made as appropriate. For example, part of the system, program, and method may be implemented by software or may be implemented by hardware. The disclosure can also be implemented as a recording medium for a program for controlling the system. It should be understood that the recording medium for the program may be a magnetic recording medium or a semiconductor memory, or may be any recording medium that will be developed in the future.

### Summary of Embodiment

The above embodiment includes at least the following configurations. The signs in parentheses represent, but are not limited to, the corresponding components in the above embodiment.

A battery control system (10) includes: an acquisition unit (21a) configured to acquire either or both of reservation information (30b) indicating a reservation time for a charging facility (300) configured to perform charging of a battery (40) mounted on a vehicle and surrounding vehicle information indicating any surrounding vehicle located within a predetermined range including the charging facility (300); and a determination unit (21b) configured to determine, based on either or both of the reservation information (30b) and the surrounding vehicle information, whether a conflict of the charging is estimated to occur at the charging facility (300). The determination unit (21b) is configured to temporarily reduce a battery protection function when the conflict of the charging is estimated to occur. The battery protection function is a function to restrain degradation of the battery (40). This configuration can increase the possibility of reducing the charger wait time of another vehicle that has reserved the charging facility while allowing the vehicle being charged to have the amount of charge desired by a user (allowing the amount of charge to reach a target value).

In the battery control system (10), the determination unit (21b) is configured to estimate that the conflict of the charging occurs when at least one of the following conditions is satisfied: there is a vehicle waiting at the charging facility (300) for the charging of the battery (40) based on the surrounding vehicle information; the number of vehicles that are located within the predetermined range and in which the battery (40) has a remaining capacity equal to or less than a threshold is larger than a reference based on the surrounding vehicle information; and a time when the charging of the vehicle at the charging facility (300) is estimated to be completed in a case where the charging is performed using the battery protection function falls in the reservation time for the charging, based on the reservation information (30b). With this configuration, the possibility of a charging conflict with another vehicle can be determined based on information on the vehicle waiting for a charger at the charging facility, the surrounding vehicle information, information on any other vehicle that have reserved the charging facility, etc.

In the battery control system (10), the determination unit (21b) is configured to estimate that the conflict of the charging occurs when determination is made, based on the reservation information (30b), that there is a plurality of reservations for the same charging facility (300). With this configuration, when there is a plurality of reservations for the same charging facility, a conflict is more likely to occur at the same charging facility. However, reducing the battery protection function can reduce the possibility that the target amount of charge set by the user may not be achieved and the possibility that another vehicle may have to wait a long time for a charger

In the battery control system (10), temporarily reducing the battery protection function is either or both of the following controls: a control of increasing a temperature limit of the battery (40) by a predetermined temperature from a default temperature for restraining degradation of the battery (40), and a control of cooling the battery (40). With this configuration, increasing the temperature limit of the battery or cooling the battery allows the amount of charge to more quickly reach the target value and reduces occurrence of a conflict, compared to the case where the charging is continued using the battery protection function.

In the present embodiment, a server (100) includes: an acquisition unit (21a) configured to acquire either or both of reservation information (30b) indicating a reservation time for a charging facility (300) configured to perform charging of a battery (40) mounted on a vehicle and surrounding vehicle information indicating any surrounding vehicle located within a predetermined range including the charging facility (300); and a determination unit (21b) configured to determine, based on either or both of the reservation information (30b) and the surrounding vehicle information, whether a conflict of the charging is estimated to occur at the charging facility (300). The determination unit (21b) is configured to instruct an external device to temporarily reduce a battery protection function when the conflict of the charging is estimated to occur. The battery protection function is a function to restrain degradation of the battery (40). This configuration can increase the possibility of reducing the charger wait time of another vehicle that has reserved the charging facility while allowing the vehicle being charged to have the amount of charge desired by a user (allowing the amount of charge to reach a target value).

### DESCRIPTION OF THE REFERENCE NUMERALS

10 . . . battery control system, 20 . . . control unit, 21 . . . battery control program, 30 . . . recording medium, 30a . . . map information, 30a1 . . . charging facility information, 30b . . . reservation information, 40 . . . battery, 41 . . . GNSS reception unit, 42 . . . vehicle speed sensor, 43 . . . gyro sensor, 44 . . . user I/F unit, 50 . . . communication unit, 100 . . . server, 110 . . . communication unit, 120 . . . recording medium, 120a . . . reservation information, 200 . . . reservation terminal, 210 . . . user I/F unit, 300 . . . charging facility

1. A battery control system comprising:
an acquisition unit configured to acquire either or both of reservation information indicating a reservation time for a charging facility configured to perform charging of a battery mounted on a vehicle and surrounding vehicle information indicating any surrounding vehicle located within a predetermined range including the charging facility; and
a determination unit configured to determine, based on the either or both of the reservation information and the surrounding vehicle information, whether a conflict of the charging is estimated to occur at the charging facility, wherein the determination unit is configured to temporarily reduce a battery protection function when the conflict of the charging is estimated to occur, the battery protection function being a function to restrain degradation of the battery.

2. The battery control system according to claim 1, wherein the determination unit is configured to estimate that the conflict of the charging occurs when at least one of the following conditions is satisfied:
there is a vehicle waiting at the charging facility for the charging of the battery based on the surrounding vehicle information; the number of vehicles that are located within the predetermined range and in which the battery has a remaining capacity equal to or less than a threshold is larger than a reference based on the surrounding vehicle information; and
a time when the charging at the charging facility is estimated to be completed in a case where the charging is performed using the battery protection function falls in the reservation time for the charging, based on the reservation information.

3. The battery control system according to claim 1, wherein the determination unit is configured to estimate that the conflict of the charging occurs when determination is made, based on the reservation information, that there is a plurality of reservations for the same charging facility.

4. The battery control system according to claim 1, wherein temporarily reducing the battery protection function is either or both of the following controls:
a control of increasing a temperature limit of the battery by a predetermined temperature from a default temperature for restraining degradation of the battery, and
a control of cooling the battery.

5. A server comprising:
an acquisition unit configured to acquire either or both of reservation information indicating a reservation time for a charging facility configured to perform charging of a battery mounted on a vehicle and surrounding vehicle information indicating any surrounding vehicle located within a predetermined range including the charging facility; and
a determination unit configured to determine, based on the either or both of the reservation information and the surrounding vehicle information, whether a conflict of the charging is estimated to occur at the charging facility, wherein the determination unit is configured to instruct an external device to temporarily reduce a battery protection function when the conflict of the charging is estimated to occur, the battery protection function being a function to restrain degradation of the battery.
